(19) United States
(12) Patent Application Publication
(10) Pub. No.: US 2023/0132116 A1
(43) Pub. Date: Apr. 27, 2023

(54) PREDICTION OF IMPACT TO DATA CENTER BASED ON INDIVIDUAL DEVICE ISSUE

(71) Applicant: Dell Products L.P., Round Rock, TX (US)

(72) Inventors: Parminder Singh Sethi, Ludhiana (IN); Lakshmi Saroja Nalam, Bangalore (IN); Durai S. Singh, Chennai (IN)

(21) Appl. No.: 17/506,895

(22) Filed: Oct. 21, 2021

(51) Int. Cl. G06N 7/00

(52) U.S. Cl. CPC G06N 7/005

(57) ABSTRACT

Predictive techniques for issue impact management in a data center or other computing environment comprising a plurality of devices are disclosed. For example, a method comprises predicting an impact to a data center comprising a plurality of devices based on an issue associated with a given device of the plurality of devices within the data center, wherein the prediction utilizes at least one machine learning model. The method then causes one or more actions to be taken based on a result of the prediction.

### FIELD

The field relates generally to information processing systems, and more particularly to issue impact management in such information processing systems.

### BACKGROUND

Data centers are the backbone of modern businesses. They are hubs of significant computing, storage, and networking activity. Data centers house a very large number of devices such as, but not limited to, servers, storage arrays, and networking devices. Continuous monitoring of devices in the data center is necessary to ensure reliability and to improve efficiency and performance. Unplanned data center outages and downtime can result in loss of business and revenue. Information technology (IT) administrators rely heavily on data center monitoring applications to keep the data center up and running. Data center monitoring applications attempt to detect issues that occur on devices in the data center. However, such data center monitoring applications are limited in their effectiveness.

### SUMMARY

Illustrative embodiments provide predictive techniques for issue impact management in a data center or other computing environment comprising a plurality of devices.

For example, in an illustrative embodiment, a method comprises predicting an impact to a data center comprising a plurality of devices based on an issue associated with a given device of the plurality of devices within the data center, wherein the prediction utilizes at least one machine learning model. The method then causes one or more actions to be taken based on a result of the prediction.

Advantageously, illustrative embodiments determine how a problematic device will likely impact the functionality and performance of the data center as a whole by calculating the probable transition states of affected/connected devices and the data center. In one or more illustrative embodiments, the method utilizes a Baum-Welch algorithm to train the machine learning model (e.g. Hidden Markov Model) and a Viterbi algorithm to predict the next states of the data center based on the next states of the problematic device and affected/connected devices.

Further illustrative embodiments are provided in the form of non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 illustrates a data center according to an illustrative embodiment.

FIG. 2 illustrates an example of information in a historic support ticket according to an illustrative embodiment.

FIG. 3 illustrates a transition state diagram for a device according to an illustrative embodiment.

FIG. 4 illustrates a further example of information in a historic support ticket according to an illustrative embodiment.

FIG. 5 illustrates a transition state diagram for a data center according to an illustrative embodiment.

FIG. 6 illustrates transmission and emission matrices associated with a Hidden Markov Model according to an illustrative embodiment.

FIG. 7 illustrates a data center categorized by functionality according to an illustrative embodiment.

FIG. 8 illustrates a Viterbi algorithm using a Hidden Markov Model according to an illustrative embodiment.

FIG. 9 illustrates an example of data center hidden states according to an illustrative embodiment.

FIG. 10 illustrates a solution to the FIG. 9 example using a Viterbi algorithm according to an illustrative embodiment.

FIG. 11 illustrates a predicted data center state sequence based on the FIG. 10 solution according to an illustrative embodiment.

FIG. 12 illustrates an example of a first data set of device transition state probabilities according to an illustrative embodiment.

FIG. 13 illustrates an example of a second data set of device transition state probabilities according to an illustrative embodiment.

FIG. 14 illustrates an example of next states of a data center using a Hidden Markov Model according to an illustrative embodiment.

FIG. 15 illustrates a Viterbi-based methodology for predicting impact to a data center based on an issue of a device in the data center according to an illustrative embodiment.

FIG. 16 illustrates a computing environment for a Viterbi-based prediction engine according to an illustrative embodiment.

FIG. 17 illustrates a processing platform used to implement an information processing system for predicting impact to a data center based on an issue of a device in the data center according to an illustrative embodiment.

### DETAILED DESCRIPTION

Illustrative embodiments will be described herein with reference to exemplary information processing systems and associated host devices, storage devices, network devices and other processing devices. It is to be appreciated, however, that these and other embodiments are not restricted to the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other cloud-based system that includes one or more clouds hosting multiple tenants that share cloud resources. Numerous different types of enterprise computing and storage systems are also encompassed by the term “information processing system” as that term is broadly used herein.

A data center is a facility that houses hardware that supports data processing, data storage, and data transport. The hardware units (i.e., example of devices) in the data center cater to the computing, data storage, and networking needs of the business operations. Modern data centers are designed to centralize data processing and keep processes running with as little downtime as possible. The various devices that are present in the data center include, for example, servers, networking switches, storage devices, cables, power equipment, cooling systems, and security systems, to name a few.

IT administrators depend on systems management and monitoring applications to manage and monitor the various devices that are present in the data center. These applications continuously monitor all the devices and they attempt to detect issues that may occur on the individual devices within the data center. When a critical issue is detected on a device, the systems management and monitoring application automatically creates a support request with the IT service provider. Additionally, the application collects telemetry information from the individual devices and uploads them to the IT service provider's backend database. The collection and upload of the telemetry information can occur as follows:

(i) Automated (i.e., initiated automatically by the application) including alert-based collection (i.e., as soon as a critical alert is detected by the application), and periodic (i.e., at regular intervals, e.g., weekly, monthly, etc., as defined in the application); or

(ii) Manual (i.e., initiated by the IT administrator).

The uploaded telemetry information available at the backend database enables the service provider's IT help desk to identify the root cause of the issue and provide an appropriate solution.

Data centers have a very large number of devices that are connected to work cohesively and support business operations. As the devices are interconnected, an issue (e.g., problem) with an individual device may also affect the processing, data storage, and data transmission across other devices that are connected to the problematic device. Systems management and monitoring applications can attempt to detect issues that occur in individual devices. However, there are no existing methods to predict how the performance and functions of the overall data center will be affected when a critical issue occurs on an individual device.

Illustrative embodiments overcome the above and other drawbacks with existing systems management and monitoring applications by providing data center impact prediction that may, for example, enhance the capability of the systems management and monitoring applications to predict the impact to the overall data center when an issue is detected in an individual device. For example, consider device A as a production server, device B as a data share, and device C as a gateway, the solution takes as inputs the current observed state of the devices A, B, and C and determines the overall impact to the functionality of the data center. The current observed state of these devices (A, B, and C) may impact certain functions (e.g., example of states) of the data center such as transaction processing, data backup, and restoration, running scheduled tasks, etc.

A data center impact prediction methodology according to one or more illustrative embodiments comprises the following stages:

Stage 1: Identifying connected devices.

Stage 2: Determining the transition of states by collating the device states using telemetry information, i.e., the transition state of the problematic device and other devices that are connected to it, and the transition state of the data center.

Stage 3: Training of a machine learning model using a Baum-Welch algorithm.

Stage 4: Determining the hidden states of the data center using a Viterbi algorithm.

Stage 5: Predicting the data center next states based on the next states of the device.

The following description further explains each of the illustrative stages. It is to be appreciated that more stages, less stages, and/or different stages, can be employed in alternative embodiments. It is also understood that, in some embodiments, one or more of the stages are implemented within a systems management and monitoring application.

Stage 1: Identifying connected devices

Using the collected telemetry information, the data center impact prediction methodology derives a network topology diagram of the data center. From the network topology diagram, the data center impact prediction methodology identifies other devices in the data center that are connected (will be impacted) to the problematic device.

In some embodiments, data centers may have a storage area network (SAN) configuration, a network attached storage (NAS) configuration, and several devices.

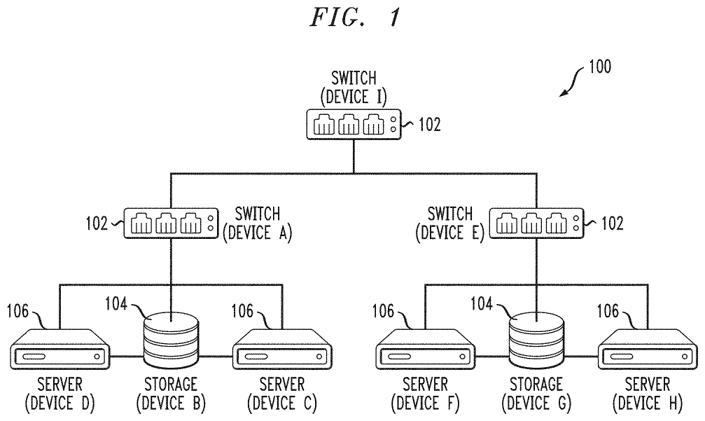

FIG. 1 illustrates an exemplary data center 100 with a SAN configuration with a plurality of network switch devices 102, a plurality of storage devices 104, and a plurality of server devices 106. As generally shown, network switch devices 102, storage devices 104, and server devices 106 are interconnected in a given configuration based on IT operational needs.

The attributes that are part of the telemetry information that is collected by the data center impact prediction methodology of the systems management and monitoring application from these devices enable the creation of a network topology diagram. For example, network switch device 102 telemetry can be obtained from virtual local area network (VLAN) information which helps to identify the storage device(s) 104 and/or server device(s) 106 that are connected to each switch and/or group. Server/storage telemetry can be obtained from Internet Small Computer Systems Interface (i SC SI) information which provides details of the connected devices.

Stage 2: Determining the transition states

For a device and the other connected devices, the data center impact prediction methodology of the systems management and monitoring application, according to an illustrative embodiment, uses the historic support ticket information available in the IT service provider's backend database. The data center impact prediction methodology utilizes a Markov chain to build the transition state diagram for each device. The transition state diagram serves to identify all probable states to which the device can transition from its current state.

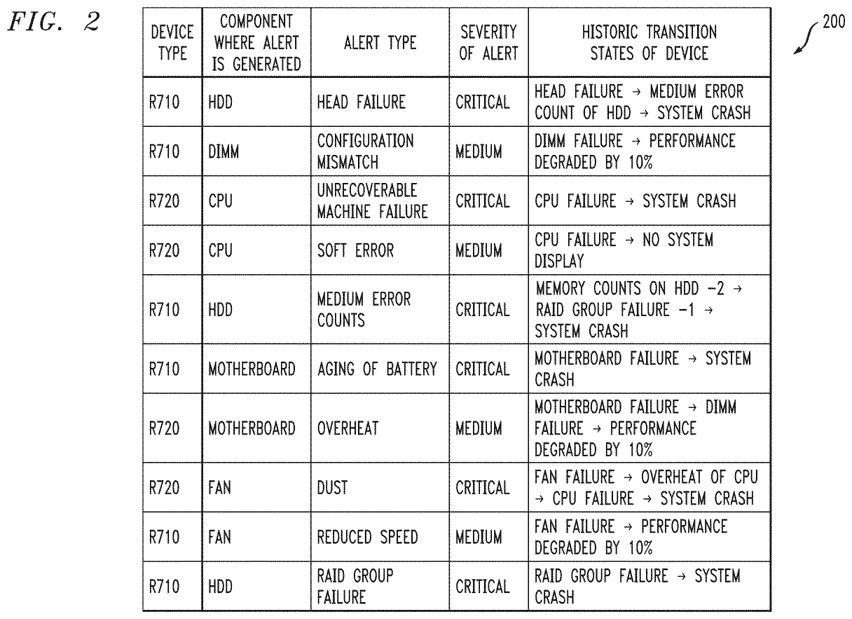

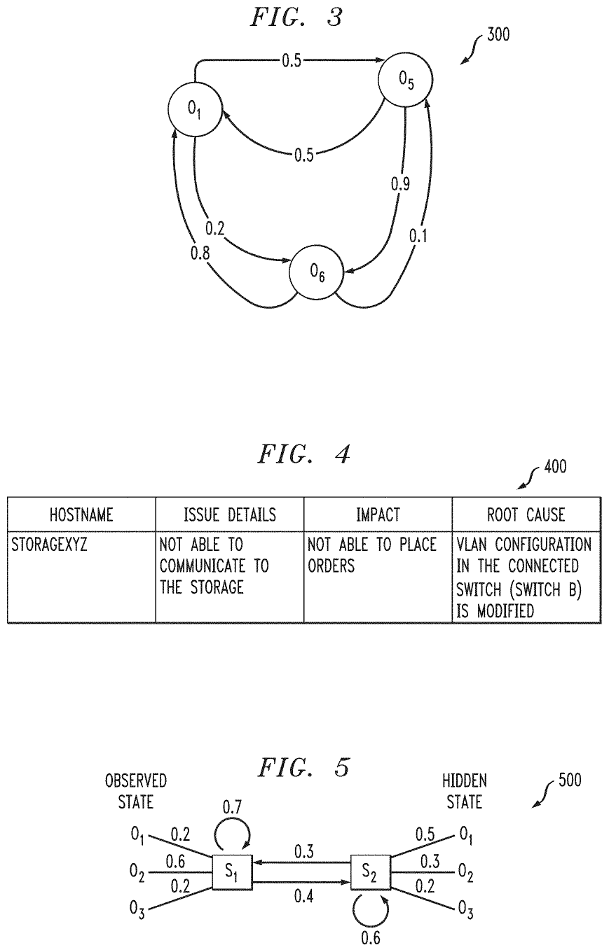

FIG. 2 illustrates a table 200 which provides an example of information that the historic support tickets can contain for various devices in a given data center. Table 200 contains, inter alia, information regarding previous transition states (e.g., head failure→medium error count on HDD→system crash) for a device (e.g., hard drive or HDD) regarding a previous issue/problem. An exemplary Markov chain that illustrates transition state for one of the devices in table 200 is shown in transition state diagram 300 of FIG. 3. O_{1 . . . n} are the various device states. FIG. 4 illustrates a table 400 which provides a further example of information that the historic support ticket can contain for a device with respect to an issue, its impact, and a root cause.

A Markov chain is a stochastic model describing a sequence of possible events in which the probability of each event depends only on the state attained in the previous event. A Hidden Markov Model (HMM) is a statistical Markov model in which the system being modeled is assumed to be a Markov process, call it S, with unobservable/hidden states. It assumes that there is another process O whose behavior depends on S. The goal is to learn about S by observing O.

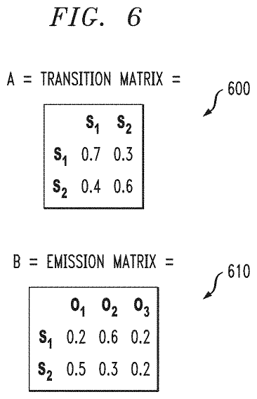

Turning now to FIG. 5, an example of a transition state diagram 500 for a data center is depicted. As shown, S₁ and S₂ are data center states and O₁, O₂, O₃ are observations/device(s) state. In an HMM, there are typically two matrices, one being referred to as a transition matrix A which determines probabilities of transitions from one hidden state to another one (the next one), and another being referred to as an emission matrix B which determines probabilities of observations given a hidden state. FIG. 6 illustrates respective examples of a transition matrix 600 and an emission matrix 610 for the example transition state diagram 500 of FIG. 5. Using the sample data in the matrices, no or the initial state distribution is computed as [S1, S2]=[0.6, 0.4].

Stage 3: Training of machine learning model

Using the Baum-Welch algorithm, in an illustrative embodiment, the HMI (which is considered a machine learning model) is trained using the transition state diagram (e.g., FIG. 5) in order to find the unknown parameters of the HMI. The Baum-Welch algorithm makes use of a forward-backward algorithm to compute the desired step. Its purpose is to tune the parameters of the HMM, namely the transition matrix A, the emission matrix B, and the initial state distribution no, such that the model is maximally like the observed data. More particularly, the forward-backward algorithm is an interference algorithm of HMM which computes the hidden state variables given a set of observations/emissions.

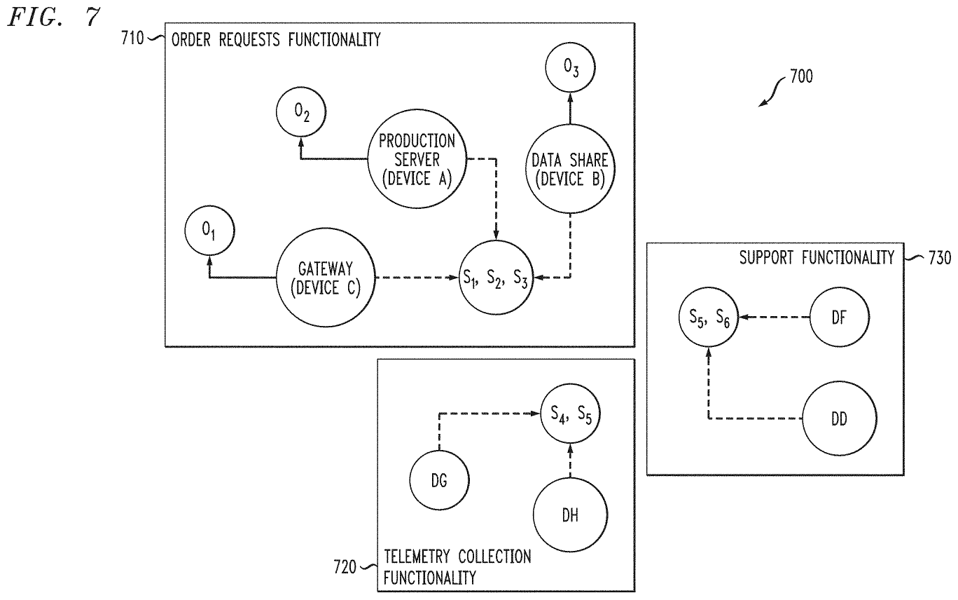

The HMM models the sequence of events (or observations) that occur one after another. In the HMM, the state of the data center is not directly visible, but only the output/observations that are dependent on the state are visible. The sequence of observations generated by the HMI provides information about the sequence of states which can be used to categorize a data center by functionality. FIG. 7 depicts a data center 700 categorized by functionality (function) according to an illustrative embodiment. By way of example, data center 700 can be categorized, as shown, by an order request functionality 710, a telemetry collection functionality 720, and a support functionality 730 wherein S₁, S₂, S₃ are data center states which are hidden and Oi, 02, 03 are observations/device states.

Stage 4: Determining the hidden states of the data center

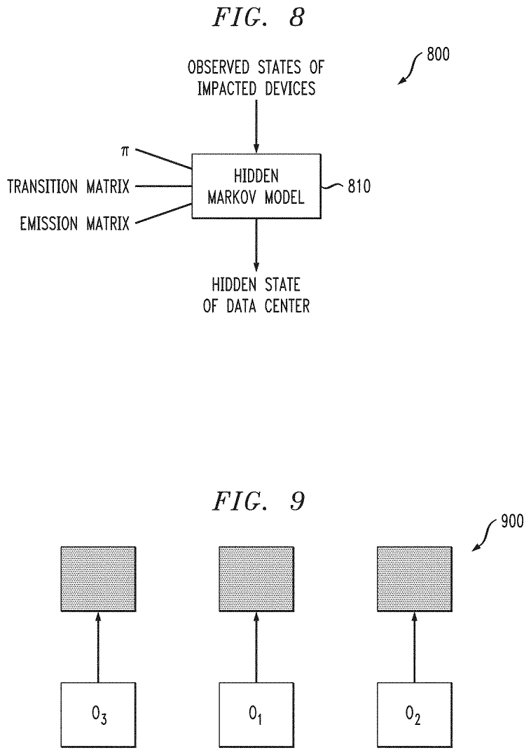

Using the Viterbi algorithm, the data center impact prediction methodology of the systems management and monitoring application, according to an illustrative embodiment, determines the most likely hidden states that result in a sequence of observed states. This algorithm uses as inputs the current observed state of both the problematic device and other connected devices. FIG. 8 illustrate the Viterbi algorithm 800 using an HMM 810.

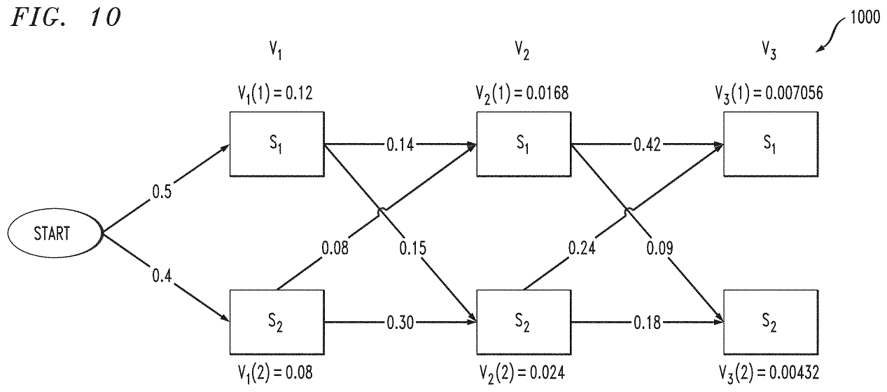

The computational formula for Viterbi algorithm 800 is P (O, ⊖)=argmax (π P(Oᵢ|Sᵢ) P(Sᵢ|Sᵢ₋₁)). For example, assuming that an observed sequence of device states as O₃ O₁ O₂, the Viterbi algorithm 800 determines the data center states which are hidden, as depicted a diagram 900 of FIG. 9. As further depicted in diagram 1000 of FIG. 10, the initial distribution (π₀) is used while calculating the first part of the sequence:

P (O₃, S₁)=P(O₃|S₁). P(S₁)=0.2*0.6=0.12=V₁(1)

P (O₃, S₂)=P(O₃|S₂). P(S₂)=0.2*0.4=0.08 32 V₁(2)

As per HMM 810, the current state depends only on the previous sequence:

P (O₁1, S₁)=P(O₁|S₁). P(S₁|S₁)=0.2*0.7=0.14

P (O₁, S₁)=P(O₁|S₁). P(S₁|S₂)=0.2*0.4=0.08

P (O₁, S₂)=P(O₁|S₂). P(S₂|S₁)=0.5*0.3=0.15

P (O₁, S₂)=P (O₁, S₂). P(S₂|S₂)=0.5*0.6=0.3

As per Viterbi algorithm 800, the maximum of the values is taken after multiplying the possible probabilities of a state:

V₂(1)=MAX (0.14*0.12=0.0168, 0.08*0.08=0.0064)=0.0168

V₂(2)=MAX (0.15*0.12=0.018, 0.30*0.08=0.024)=0.024

P (O₂, S₁)=P(O₂|S₁). P(S₁|S₁)=0.6*0.7=0.42

P (O₂, S₁)=P(O₂|S₁). P(S₁|S₂)=0.6*0.4=0.24

P (O₂, S₂)=P(O₂|S₂). P(₂|S₁)=0.3*0.3=0.09

P (O₂, S₂)=P(O₂|S₂). P(S₂|S₂)=0.3*0.6=0.18

Further, as per Viterbi algorithm 800, the maximum of the values is taken after multiplying the possible probabilities of a state:

V₃(1)=MAX (0.42*0.0168=0.007056, 0.24*0.024=0.00576)=0.007056

V₃(2)=MAX (0.09*0.0168=0.001512, 0.18*0.024=0.00432)=0.00432

Then, Viterbi algorithm 800 finds the maximum possible probability to find the hidden state:

V₁=MAX(V₁(1), V₁(2))=MAX (0.12, 0.08)=0.12=S1

V₂=MAX(V₂(1), V₂(2))=MAX (0.0168, 0.024)=0.024=S2

V₃=MAX(V₃(1), V₃(2))=MAX (0.007056, 0.00432)=0.007056 =S1

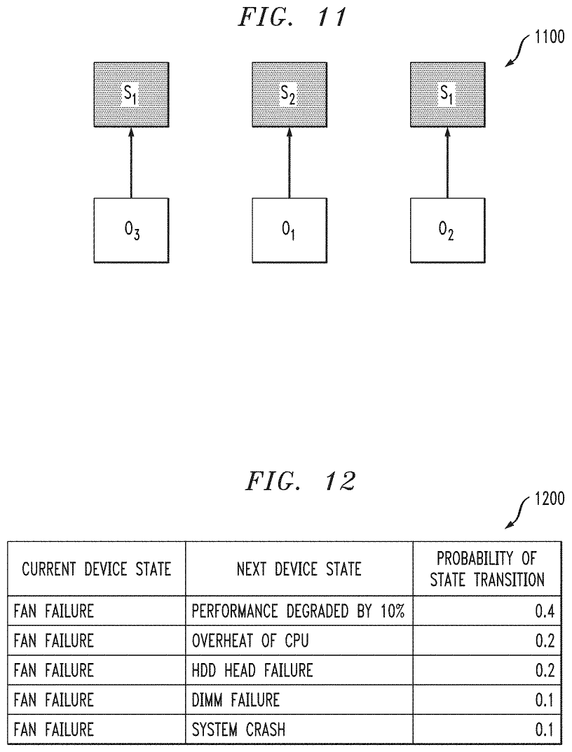

Hence, for the sequence O₃, O₁, O₂, the hidden state sequence (i.e., data center state sequence) is depicted in diagram 1100 of FIG. 11.

Stage 5: Predicting the data center next states based on the next states of the device

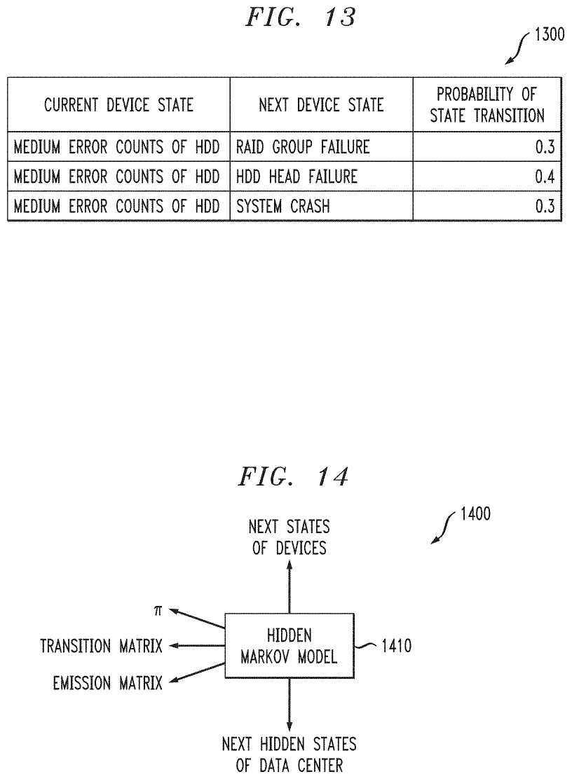

With the telemetry data and device application logs (e.g., stage 2 described above), the data center impact prediction methodology of the systems management and monitoring application, according to an illustrative embodiment, derives tables 1200 and 1300 of FIGS. 12 and 13, respectively. More particularly, tables 1200 and 1300 list sample data sets collected through the telemetry data, with the current device state and the future device state. The calculated probability of the transitioned device state is listed in the third column of each of tables 1200 and 1300.

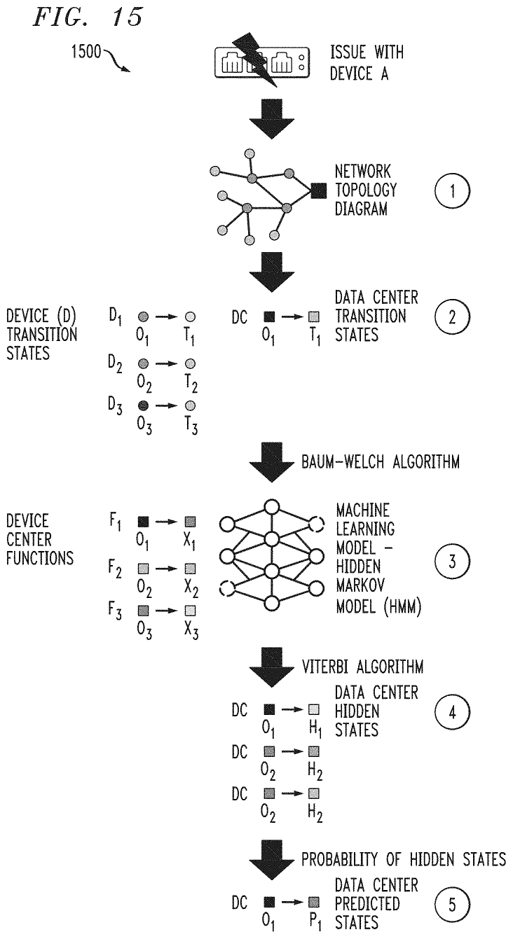

Similarly, the data center impact prediction methodology derives the probability for the rest of the device states. As shown in a process 1400 in FIG. 14, device next states data is fed to HMM 1410 to determine the next states of the data center.

FIG. 15 illustrates a Viterbi-based methodology 1500 for predicting impact to a data center based on an issue of a device in the data center according to an illustrative embodiment. More particularly, methodology 1500 is an illustration of an implementation of stages 1-5 as described above. Thus, the reference numbers 1-5 in FIG. 15 correspond to the stage 1-5 described above.

In one example, as explained herein, stages 1-5 and thus methodology 1500 can be implemented in a systems management and monitoring application (or can be standalone or implemented in some other application run for the data center) to detect an issue with a device in the data center, e.g., a network switch in the data center. Methodology 1500 predicts the state of the data center in the context of the problematic device by using the following steps as depicted in FIG. 15:

Step 1: Using the collected telemetry information, methodology 1500 derives the network topology diagram. The network topology diagram facilitates identification of other devices in the data center that are connected (will be impacted) to the problematic device.

Step 2: Methodology 1500 utilizes historic support ticket information and uses the Markov chain to determine the transition state diagram for each device and also for the data center.

Step 3: The machine learning model (HMM) is trained with the transition diagram by using the Baum-Welch algorithm and data center functionalities (functions). The machine learning model facilitates computation of the hidden state variables for a given set of observations.

Step 4: Methodology 1500 then determines the most probable hidden states based on a sequence of observed states. This stage uses the Viterbi algorithm which takes as inputs, the current observed state of both the problematic device and other connected devices.

Step 5: Using the telemetry data and the application logs of the device, methodology 1500 calculates the probability of the transitioned states enabling the prediction of the next states of the data center.

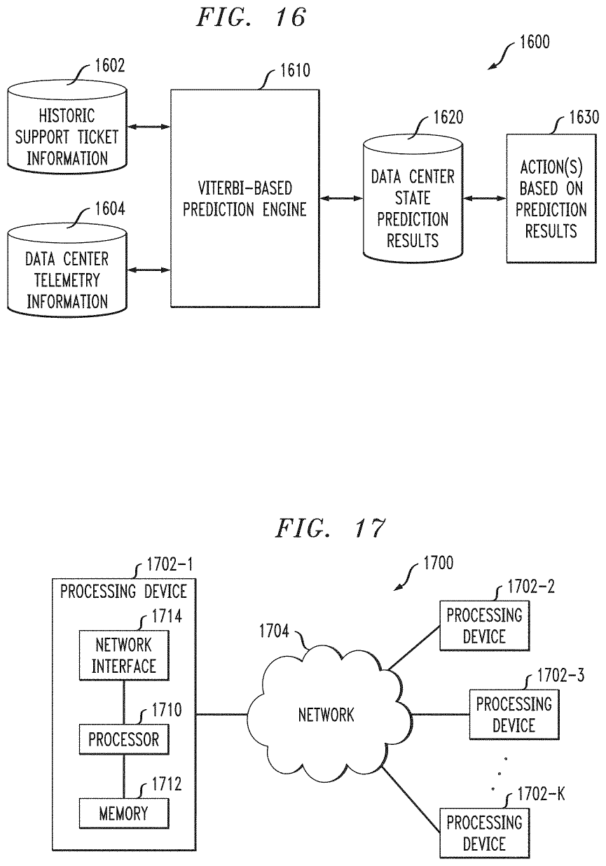

Turning now to FIG. 16, a computing environment 1600 is depicted for a Viterbi-based prediction engine 1610 according to an illustrative embodiment. It is to be understood that Viterbi-based prediction engine 1610 is configured to perform methodology 1500 of FIG. 15 based on inputs including, but not necessarily limited to, historic support ticket information 1602 and data center telemetry information 1604. As explained in detail herein, Viterbi-based prediction engine 1610 predicts the state of the data center in the context of a problematic device, which is depicted in FIG. 16 as data center state prediction results 1620. Based on at least a portion of prediction results 1620, one or more actions 1630 can be taken by IT administrators and/or automated systems to avoid or mitigate the impact that the problematic device has on connected devices and/or the data center as a whole.

Advantageously, as explained herein, illustrative embodiments determine the transition state diagram for each device in the data center by leveraging the historic support ticket information and using the Markov chain. Illustrative embodiments determine the most probable hidden states of the data center by leveraging the sequence of observed states of the devices. The hidden states are determined using the Viterbi algorithm and using the model which is trained with the Baum-Welch algorithm. Illustrative embodiments predict how an issue in an individual device will impact the functionality of the data center by calculating the probable transition states of the affected/connected devices and the data center.

FIG. 17 depicts a processing platform 1700 used to implement improved data theft protection according to an illustrative embodiment. More particularly, processing platform 1700 is a processing platform on which a computing environment with features described herein (e.g., FIGS. 1-16 and otherwise described herein) can be implemented.

The processing platform 1700 in this embodiment comprises a plurality of processing devices, denoted 1702-1, 1702-2, 1702-3, . . . 1702-K, which communicate with one another over network(s) 1704.

It is to be appreciated that the methodologies described herein may be executed in one such processing device 1702, or executed in a distributed manner across two or more such processing devices 1702. It is to be further appreciated that a server, a client device, a computing device or any other processing platform element may be viewed as an example of what is more generally referred to herein as a “processing device.” As illustrated in FIG. 17, such a device generally comprises at least one processor and an associated memory, and implements one or more functional modules for instantiating and/or controlling features of systems and methodologies described herein. Multiple elements or modules may be implemented by a single processing device in a given embodiment. Note that components described in the architectures depicted in the figures can comprise one or more of such processing devices 1702 shown in FIG. 17. The network(s) 1704 represent one or more communications networks that enable components to communicate and to transfer data therebetween, as well as to perform other functionalities described herein.

The processing device 1702-1 in the processing platform 1700 comprises a processor 1710 coupled to a memory 1712. The processor 1710 may comprise a microprocessor, a microcontroller, an application-specific integrated circuit (ASIC), a field programmable gate array (FPGA) or other type of processing circuitry, as well as portions or combinations of such circuitry elements. Components of systems as disclosed herein can be implemented at least in part in the form of one or more software programs stored in memory and executed by a processor of a processing device such as processor 1710. Memory 1712 (or other storage device) having such program code embodied therein is an example of what is more generally referred to herein as a processor-readable storage medium. Articles of manufacture comprising such computer-readable or processor-readable storage media are considered embodiments of the invention. A given such article of manufacture may comprise, for example, a storage device such as a storage disk, a storage array or an integrated circuit containing memory. The term “article of manufacture” as used herein should be understood to exclude transitory, propagating signals.

Furthermore, memory 1712 may comprise electronic memory such as random-access memory (RAM), read-only memory (ROM) or other types of memory, in any combination. The one or more software programs when executed by a processing device such as the processing device 1702-1 causes the device to perform functions associated with one or more of the components/steps of system/methodologies in FIGS. 1-16. One skilled in the art would be readily able to implement such software given the teachings provided herein. Other examples of processor-readable storage media embodying embodiments of the invention may include, for example, optical or magnetic disks.

Processing device 1702-1 also includes network interface circuitry 1714, which is used to interface the device with the networks 1704 and other system components. Such circuitry may comprise conventional transceivers of a type well known in the art.

The other processing devices 1702 (1702-2, 1702-3, . . . 1702-K) of the processing platform 1700 are assumed to be configured in a manner similar to that shown for computing device 1702-1 in the figure.

The processing platform 1700 shown in FIG. 17 may comprise additional known components such as batch processing systems, parallel processing systems, physical machines, virtual machines, virtual switches, storage volumes, etc. Again, the particular processing platform shown in this figure is presented by way of example only, and the system shown as 1700 in FIG. 17 may include additional or alternative processing platforms, as well as numerous distinct processing platforms in any combination.

Also, numerous other arrangements of servers, clients, computers, storage devices or other components are possible in processing platform 1700. Such components can communicate with other elements of the processing platform 1700 over any type of network, such as a wide area network (WAN), a local area network (LAN), a satellite network, a telephone or cable network, or various portions or combinations of these and other types of networks.

Furthermore, it is to be appreciated that the processing platform 1700 of FIG. 17 can comprise virtual (logical) processing elements implemented using a hypervisor. A hypervisor is an example of what is more generally referred to herein as “virtualization infrastructure.” The hypervisor runs on physical infrastructure. As such, the techniques illustratively described herein can be provided in accordance with one or more cloud services. The cloud services thus run on respective ones of the virtual machines under the control of the hypervisor. Processing platform 1700 may also include multiple hypervisors, each running on its own physical infrastructure. Portions of that physical infrastructure might be virtualized.

As is known, virtual machines are logical processing elements that may be instantiated on one or more physical processing elements (e.g., servers, computers, processing devices). That is, a “virtual machine” generally refers to a software implementation of a machine (i.e., a computer) that executes programs like a physical machine. Thus, different virtual machines can run different operating systems and multiple applications on the same physical computer. Virtualization is implemented by the hypervisor which is directly inserted on top of the computer hardware in order to allocate hardware resources of the physical computer dynamically and transparently. The hypervisor affords the ability for multiple operating systems to run concurrently on a single physical computer and share hardware resources with each other.

It was noted above that portions of the computing environment may be implemented using one or more processing platforms. A given such processing platform comprises at least one processing device comprising a processor coupled to a memory, and the processing device may be implemented at least in part utilizing one or more virtual machines, containers or other virtualization infrastructure. By way of example, such containers may be Docker containers or other types of containers.

The particular processing operations and other system functionality described in conjunction with FIGS. 1-17 are presented by way of illustrative example only, and should not be construed as limiting the scope of the disclosure in any way. Alternative embodiments can use other types of operations and protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should again be emphasized that the above-described embodiments of the invention are presented for purposes of illustration only. Many variations may be made in the particular arrangements shown. For example, although described in the context of particular system and device configurations, the techniques are applicable to a wide variety of other types of data processing systems, processing devices and distributed virtual infrastructure arrangements. In addition, any simplifying assumptions made above in the course of describing the illustrative embodiments should also be viewed as exemplary rather than as requirements or limitations of the invention.

What is claimed is:

1. An apparatus comprising:
at least one processing device comprising a processor coupled to a memory;
the at least one processing device being configured to:
predict an impact to a data center comprising a plurality of devices based on an issue associated with a given device of the plurality of devices within the data center, wherein the prediction utilizes at least one machine learning model; and
cause one or more actions to be taken based on a result of the prediction.

2. The apparatus of claim 1, wherein predicting an impact to a data center based on an issue associated with a given device within the data center further comprises identifying any devices of the plurality of devices that are connected to the given device.

3. The apparatus of claim 2, wherein identifying any devices of the plurality of devices that are connected to the given device further comprises:
collecting information from the data center;
generating a network topology diagram of the data center based on at least a portion of the collected information; and
identifying any connected devices based on the network topology diagram.

4. The apparatus of claim 2, wherein predicting an impact to a data center based on an issue associated with a given device within the data center further comprises determining transition states of the data center, the given device, and any devices that are connected to the given device.

5. The apparatus of claim 4, wherein determining transition states of the data center, the given device, and any devices that are connected to the given device further comprises:
collecting historic support ticket information from the data center; and
generating transition state diagrams for the data center, the given device, and any devices that are connected to the given device using a Markov chain and at least a portion of the historic support ticket information.

6. The apparatus of claim 4, wherein predicting an impact to a data center based on an issue associated with a given device within the data center further comprises training the machine learning model using the transition states of the data center, the given device, and any devices that are connected to the given device.

7. The apparatus of claim 6, wherein training the machine learning model using the transition states of the data center, the given device, and any devices that are connected to the given device further comprises using a Baum-Welch algorithm with the transition states and data center functionalities of the data center to determine possible hidden states of the data center based on observed states of the given device and any devices that are connected to the given device.

8. The apparatus of claim 6, wherein predicting an impact to a data center based on an issue associated with a given device within the data center further comprises using a Viterbi algorithm to compute most probable hidden states of the data center.

9. The apparatus of claim 8, wherein predicting an impact to a data center based on an issue associated with a given device within the data center further comprises, based on results of the Viterbi algorithm, predicting next states of the data center based on the next states of the given device and any devices that are connected to the given device.

10. The apparatus of claim 1, wherein the machine learning model comprises a Hidden Markove Model.

11. A method comprising:
predicting an impact to a data center comprising a plurality of devices based on an issue associated with a given device of the plurality of devices within the data center, wherein the prediction utilizes at least one machine learning model; and
causing one or more actions to be taken based on a result of the prediction.

12. The method of claim 11, wherein predicting an impact to a data center based on an issue associated with a given device within the data center further comprises identifying any devices of the plurality of devices that are connected to the given device.

13. The method of claim 12, wherein identifying any devices of the plurality of devices that are connected to the given device further comprises:
collecting information from the data center;
generating a network topology diagram of the data center based on at least a portion of the collected information; and
identifying any connected devices based on the network topology diagram.

14. The method of claim 12, wherein predicting an impact to a data center based on an issue associated with a given device within the data center further comprises determining transition states of the data center, the given device, and any devices that are connected to the given device.

15. The method of claim 14, wherein determining transition states of the data center, the given device, and any devices that are connected to the given device further comprises:
collecting historic support ticket information from the data center; and
generating transition state diagrams for the data center, the given device, and any devices that are connected to the given device using a Markov chain and at least a portion of the historic support ticket information.

16. The method of claim 14, wherein predicting an impact to a data center based on an issue associated with a given device within the data center further comprises training the machine learning model using the transition states of the data center, the given device, and any devices that are connected to the given device.

17. The method of claim 16, wherein training the machine learning model using the transition states of the data center, the given device, and any devices that are connected to the given device further comprises using a Baum-Welch algorithm with the transition states and data center functionalities of the data center to determine possible hidden states of the data center based on observed states of the given device and any devices that are connected to the given device.

18. The apparatus of claim 16, wherein predicting an impact to a data center based on an issue associated with a given device within the data center further comprises using a Viterbi algorithm to compute most probable hidden states of the data center.

19. The apparatus of claim 18, wherein predicting an impact to a data center based on an issue associated with a given device within the data center further comprises, based on results of the Viterbi algorithm, predicting next states of the data center based on the next states of the given device and any devices that are connected to the given device.

20. A computer program product comprising a non-transitory processor-readable storage medium having stored therein program code of one or more software programs, wherein the program code when executed by at least one processing device causes the at least one processing device to perform steps of:
predicting an impact to a data center comprising a plurality of devices based on an issue associated with a given device of the plurality of devices within the data center, wherein the prediction utilizes at least one machine learning model; and
causing one or more actions to be taken based on a result of the prediction.
